(19) United States
(12) Patent Application Publication
(10) Pub. No.: US 2007/0284956 A1
(43) Pub. Date: Dec. 13, 2007

(54) Assembly for generating energy by magnetic polar repulsion

(76) Inventors: Garrett Petrovich, Lake in the Hills, IL (US); Terence Petrovich, Lake in the Hills, IL (US)

Correspondence Address: Meroni & Meroni, P.C., P.O. Box 309, Barrington, IL, 60011, US

(21) Appl. No.: 11/452,155

(22) Filed: Jun. 13, 2006

(51) Int. Cl. H02K 7/06; H02K 49/00; H02K 21/00

(52) U.S. Cl. 310/80; 310/103; 310/152

(57) ABSTRACT

An energy-generating assembly comprises a disc assembly, multiple driver magnets, and magnet holders. The disc assembly comprises a disc member, an axle, and a plurality of circumferentially spaced propeller magnets. The magnets each comprise opposing pole ends. The propeller magnets are fastened to the disc member adjacent its outer periphery via like pole ends. Certain like pole ends thereby extend outwardly from the outer periphery. The disc member is rotatable about the axle axis. The magnet holders enable the user to adjustably mount each driver magnet adjacent the outer periphery. The like magnetic poles of the driver magnets and the propeller magnets are magnetically repulsive to one another. The driver magnets are linearly displaceable via the magnet holders. The linearly displaceable driver magnets function to selectively adjust the magnetic repulsion intermediate like magnetic poles for imparting rotational motion to the disc assembly, the disc assembly for generating energy.

### BACKGROUND OF THE INVENTION

1. Field of the Invention

The present invention generally relates to a device or module for generating energy by magnetic polar repulsion. More particularly, the present invention relates to a magnetic energy polar repulsion module or energy-generating assembly operable by linear displacement of mounted magnetic components for causing harnessable rotational motion.

2. Description of the Prior Art

The prior art discloses a number of apparatuses comprising magnetic means for generating rotative motion. Some of the more pertinent prior art patents relating to the subject matter of this disclosure are briefly described hereinafter.

U.S. Pat. No. 1,481,256 ('256 patent), which issued to Dols, discloses a device comprising two horse shoe magnets set one within the other and at right angles to each other; and a flat and rayed magnetized armature having a spinning point centrally located on its under side and having magnetized rays extended radially. Further, the '256 patent teaches a device comprising a four-poled magnet having the poles spaced apart in a common plane; and a flat armature having a spinning point centrally located on its under side and having magnetized rays extended radially.

U.S. Pat. No. 3,703,653 ('653 patent), which issued to Tracy et al., discloses a Reciprocating Motor with Motion Conversion Means. The '653 patent teaches a permanent magnet motor which utilizes pairs of permanent magnets as the power source for the motor. The magnets of each pair are arranged with their like poles adjacent one another so that normally the magnets of the pairs oppose or repel one another. Shiftable means are provided for being for being inserted between the magnets of each pair so as to then to alter the magnetic field between the magnets to cause the magnets to move toward one another with considerable force. One magnet of each pair is connected to a common drive shaft member. The shiftable means for being inserted between and withdrawn from the magnets of each pair are shifted by any suitable means in timed relationship with one another.

U.S. Pat. No. 3,801,095 ('095 patent), which issued to Woron, discloses a Magnetic Amusement Device. The '095 patent teaches a disc supporting a first magnet at its periphery causing it to revolve by magnetic induction due to movement of a second magnet adjacent but spaced from the periphery of the disc. The second magnet is mounted for reciprocal movement in a direction generally parallel to the axis of rotation of said disc.

U.S. Pat. No. 4,267,647 ('647 patent) which issued to Anderson Jr., et al., discloses an Apparatus for Demonstrating Magnetic Force. The '647 patent teaches an apparatus for demonstrating magnetic force comprises a plurality of disc-shaped rotors angularly displaced from each other on a common shaft and a number of magnets equispaced along the rims of the rotors. Stationary field magnets encircle the rotors in close proximity to the rotor magnets with like-poles of the rotor magnets and the field magnets facing each other. A high permeance magnetic shield is located in the air gap between each field magnet and the rotor to block opposing magnetic fluxes. Magnetic attraction between the rotor magnets and field magnets tend to rotate the rotor. In one embodiment, the shield at each field magnet is mounted on a pivot and is moved out of the air gap by arms attached to the rotor. The rotor magnets are first attracted to the magnetic shield, and, as a corresponding rotor and field magnet approach each other during rotation of the rotor, one of the arms causes the shield to pivot out of the gap to expose the rotor magnet to the field magnet. This creates a magnetic repulsion “kick” tending to further rotate the rotor. A weighted portion of the shield below the pivot, and an additional set of arms rotating with the rotor, automatically reposition the shield during rotation of the rotor. In another embodiment, stationary magnetic shielding located in the air gap is shaped to block only a portion of each field magnet from the gap. As the rotor is rotated toward the shielding by magnetic attraction, a “flywheel effect” causes the rotor magnet to swing past the shielding into view of the partially exposed field magnet to create the additional kick.

U.S. Pat. No. 4,964,930 ('830 patent), which issued to Wagner, discloses a Magnetic Device. The '830 patent teaches a magnetic device that may be used for storing and dispensing paper clips, and the like, and which may also be used as an amusement or novelty product. A plastic housing houses a bar magnet with the poles arranged vertically. The bar magnet is positioned near but spaced from the upper surface of the housing by a spacer disc made of magnetizable material. The spacer disc has a central opening, above which opening, on the housing's upper surface, magnetic lines of induction are produced that tend to orient a paper clip, or the like, vertically on end and which also allow for prolonged gyratory motion of the paper clip about the end. A plastic, transparent casing may be provided housing iron powder or tiny magnet bits of different shape, which casing is slidably and rotatably mounted with respect to the upper surface of the housing, so that, as the casing is slid or rotated, different patterns are formed in kaleidoscope-fashion.

U.S. Pat. No. 5,854,526 ('526 patent), which issued to Sakamoto, discloses a Three Phase Permanent Magnet Electric Rotating Machine. The '526 patent teaches a three-phase permanent-magnet electric rotating machine having necessary performance which can be realized easily at a low cost, wherein a stator includes a stator iron core having a disc portion and 3n magnetic poles formed so as to be erected at right angles from an outer circumference of the disc portion, and excitation windings mounted on the magnetic poles so as to have a predetermined width in the axial direction, and wherein a rotor is constituted by permanent magnets magnetized into N and S poles arranged alternately in the direction of rotation of the rotor and the rotor is supported so as to face the top ends of the respective magnetic poles of the stator through a predetermined air gap. In this case, the number n is an integer not smaller than 1. Alternatively, n may be selected to be an even number not smaller than 2 so that the excitation windings may be mounted on every other one of the magnetic poles. Preferably, a plurality of magnetic teeth of a predetermined shape may be formed on each of the top end portions of the magnetic poles formed in the stator iron core. Further preferably, excitation windings are mounted on first and second stator iron cores which are doubly arranged so as to be concentric with each other to thereby form a stator provided with a double structure of the magnetic poles.

U.S. Pat. No. 6,150,913 ('913 patent), which issued to Simmons, discloses a magnetically activated disc has a flat bipolar ring magnet mounted concentrically on the upper surface of the disc. The bottom surface of the disc has a protruding center point which provides an axis around which the disc can spin. The disc has a sidewall on the upper surface extending upwardly around the circumference of the disc to form an open cavity for holding a removable disc having a design imprinted on its upper surface. An external permanent magnet is manipulated so that its magnetic field acts upon the bipolar ring magnet, thereby causing the disc to spin around the protruding center point so that the disc with the imprinted design produces a desired visual effect.

U.S. Pat. No. 6,420,810 ('810 patent), which issued to Jeong, describes a non-contact driving motor capable of keeping its non-contact state irrespective of its start-up or stoppage condition, thereby obtaining a semi-permanent durability. The motor including a housing, a sleeve extending upwardly from the housing, a stator assembly fitted around the sleeve, a vertical shaft rotatably inserted in the sleeve, a rotor assembly including a rotor case coupled to an upper end of the shaft, and an annular driving magnet attached to an outer peripheral end of the rotor case in such a fashion that it faces the stator assembly, an annular first magnet attached to an inner peripheral surface of the sleeve at an upper end of the sleeve, an annular second magnet attached to an outer peripheral surface of the shaft in such a fashion that it faces the first magnet in a horizontal direction, a disc-shaped third magnet fitted around a lower end of the shaft, a disc-shaped fourth magnet attached to the inner peripheral surface of the sleeve above the third magnet in such a fashion that it faces the third magnet in a vertical direction, and a disc-shaped fifth magnet attached to a cap covering the lower end of the sleeve beneath the third magnet in such a fashion that it faces the third magnet in a vertical direction.

U.S. Pat. No. 6,552,460 ('460 patent), which issued to Bales, involves an electromotive machine having a stator element and a rotor element, the stator element including at least one set of four toroidally shaped electromagnetic members, the electromagnetic members arranged along an arc a predetermined distance apart defining a stator arc length. Each of the members has a slot, and the rotor element includes a disc adapted to pass through the slots. The disc contains a plurality of permanent magnet members spaced side by side about a periphery thereof and arranged so as to have alternating north-south polarities. These permanent magnet members are sized and spaced such that within the stator arc length the ratio of stator members to permanent magnet members is about four to six. The electromagnetic members are energized in a four phase push-pull fashion to create high torque and smooth operation.

U.S. Pat. No. 6,770,997 ('997 patent), which issued to Koeneman, discloses a micro-electromechanical homopolar generator on a substrate and a method of manufacturing the same. The micro-electromechanical homopolar generator includes first substrate layer having an axial rotor contact portion and a radial edge portion, each having conductive contacts. An axial contact brush and a radial edge brush are coupled to the first and second conductive contacts, respectively. At least one conductive disc is axially aligned with the axial rotor contact portion and a peripheral edge of the conductive disc is proximate the radial edge portion. The axial contact brush and the radial edge brush respectively form an electrical contact with an axial portion and a peripheral edge portion of the conductive disc. At least one magnet is spaced from the conductive disc to define a magnetic field aligned with an axis of rotation of the conductive disc.

U.S. Pat. No. 6,897,579 ('579 patent), which issued to Aoshima, describes a motor which includes a magnet formed into a hollow disc shape and having at least one flat surface circumferentially divided and alternately magnetized to opposite poles, a first coil having an inner peripheral surface opposing the outer peripheral surface of the magnet, a second coil having an outer peripheral surface opposing the inner peripheral surface of the magnet, first magnetic pole portions opposing one flat surface of the magnet, formed from a plurality of teeth extending in the radial direction of the magnet, and excited by the first coil, second magnetic pole portions formed on the opposite side to the first magnetic pole portions via the magnet at positions opposing the first magnetic pole portions, third magnetic pole portions opposing one flat surface of the magnet, formed from a plurality of teeth extending in the radial direction of the magnet, and excited by the second coil, and fourth magnetic pole portions formed on the opposite side to the third magnetic pole portions via the magnet at positions opposing the third magnetic pole portions.

### SUMMARY OF THE INVENTION

Accordingly, it is a primary object of the present invention to provide an energy-generating assembly, which assembly generates energy by magnetic polar repulsion. Thus, it may be said that the invention provides certain preferred and certain alternative magnetic energy polar repulsion modules. The magnetic energy polar repulsion module or energy-generating assembly essentially comprises a disc assembly, a plurality of driver magnets, and certain magnet-displacing means. The disc assembly comprises a circular, non-ferromagnetic disc member, a disc axle, and a plurality of circumferentially spaced propeller magnets. The disc member comprises an outer periphery, a disc center, and first and second attachment surfaces. The disc axle comprises an axle axis, the disc axle being cooperable with the disc member, the axle axis extending through the disc center.

The propeller magnets each comprise opposing first and second propeller pole ends and a propeller magnet axis. The propeller magnets are staggered and fastened to the first and second attachment surfaces adjacent to the outer periphery via the second propeller pole ends at pole-attachment points. The propeller magnet axes extend in coplanar relation to one another in parallel planes adjacent the axle axis. The first propeller pole ends thus extend non-orthogonally and outwardly from the outer periphery. The disc member is rotatable about the axle axis.

The driver magnet has first and second driver pole ends and a driver magnet axis. Each driver magnet is spatially oriented in adjacency to the outer periphery. Each first driver pole end and the first propeller pole ends have like magnetic poles, the like magnetic poles being magnetically repulsive to one another. The driver magnet is linearly displaceable adjacent the outer periphery via the magnet-displacing means. The linearly displaceable driver magnet function to selectively adjust the magnetic repulsion intermediate the like magnetic poles for imparting rotational motion to the disc assembly, the rotational disc assembly for generating energy.

It is a further object of the present invention to provide an alternative energy-generating assembly comprising like first and second disc assemblies and disc-displacing means. In this regard, each disc assembly comprising a circular, non-ferromagnetic disc member, a disc axle, and a plurality of circumferentially spaced propeller magnets. Each disc member comprises an outer periphery, a disc center, a disc diameter and a planar disc-opposing surface. Each disc axle comprises an axle axis, the disc axles being cooperable with the disc members, the axle axes extending through the disc centers.

The propeller magnets each comprise opposing first and second propeller pole ends and a propeller magnet axis. The propeller magnets are fastened to the outer periphery via the second propeller pole ends. The disc-opposing surfaces of the first and second disc assemblies oppose one another, the axle axes being collinear. The first propeller pole ends extend toward an opposite disc-opposing surface, angled relative thereto. The first disc assembly is rotatable about its axle axis and the second disc assembly is rotatably fixed relative to its axle axis.

The first propeller pole ends having like magnetic poles, the like magnetic poles being magnetically repulsive to one another. The first and second disc assemblies are axially displaceable relative to one another via the disc-displacing means. The axially displaceable disc assemblies function to selectively adjust the magnetic repulsion intermediate the like magnetic poles for imparting rotational motion to the first disc assembly, the rotational first disc assembly for generating energy.

Other objects of the present invention, as well as particular features, elements, and advantages thereof, will be elucidated or become apparent from, the following description and the accompanying drawing figures.

### BRIEF DESCRIPTION OF THE DRAWINGS

Other features of our invention will become more evident from a consideration of the following brief description of patent drawings:

FIG. 1 is a top plan view of the preferred embodiment of the energy-generating assembly of the present invention showing a plurality of propeller magnets mounted to a disc member and four circumferentially spaced driver magnets.

FIG. 1(a) is a fragmentary enlarged view of a propeller magnet mounted to a disc member and a driver magnet depicting a repulsive force vector extending intermediate like magnetic poles.

FIG. 1(b) is a coordinate system depiction of the repulsive force depicted in FIG. 1(a) depicting the component force vectors.

FIG. 2 is a fragmentary side view depiction of the disc assembly of the preferred embodiment of the present invention.

FIG. 3 is a fragmentary enlarged top plan view depiction of a portion of the preferred embodiment of the energy-generating assembly of the present invention showing a plurality of propeller magnets mounted to a disc member and a driver magnet.

FIG. 4 is a fragmentary side view depiction of a first alternative embodiment of the energy-generating assembly of the present invention showing two like disc assemblies opposing one another, one of which has an axis of rotation and one of which has a fixed axis.

FIG. 5 is a fragmentary enlarged side view depiction of a bottom portion of the first alternative embodiment depicting a repulsive force vector extending intermediate like magnetic poles.

FIG. 5(a) is a depiction of the repulsive force depicted in FIG. 5 depicting the component force vectors.

FIG. 6 is a side view depiction of the first a first alternative embodiment of the energy-generating assembly of the present invention shown adjacent a generic rotational motion-harnessing device.

### DETAILED DESCRIPTION OF THE PREFERRED EMBODIMENT(S)

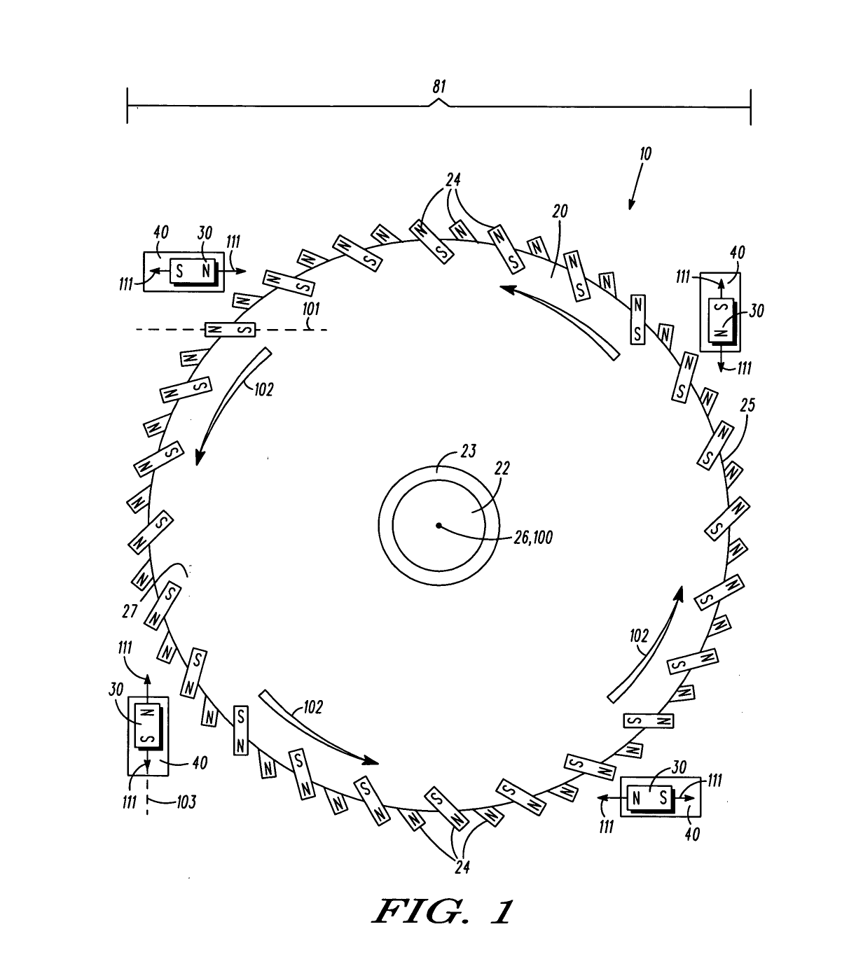

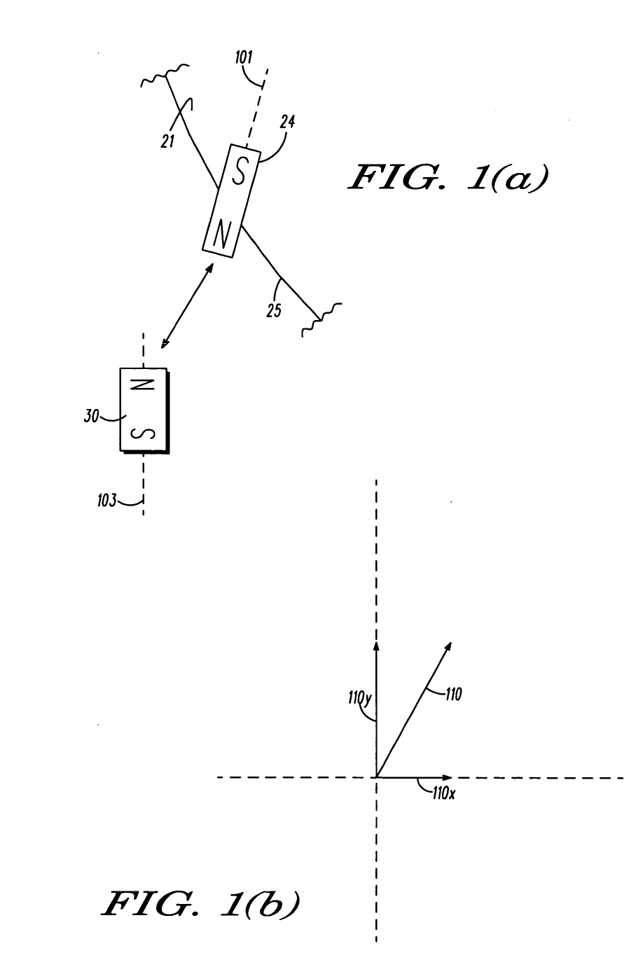

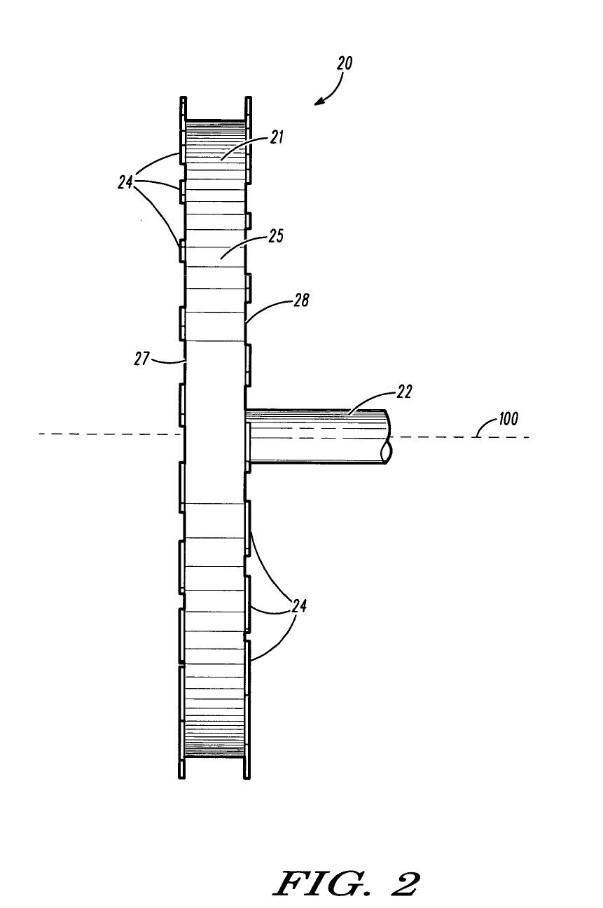

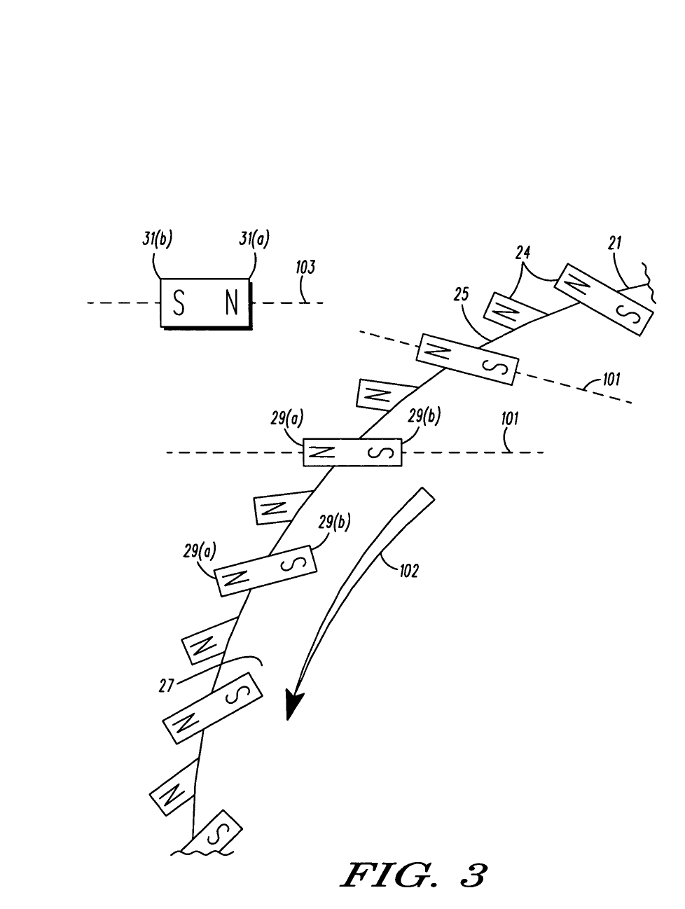

Referring now to the drawings, the preferred embodiment of the present invention concerns an energy-generating assembly 10 as generally referenced and depicted in FIG. 1. Energy-generating assembly 10 preferably comprises a disc assembly 20 as illustrated and referenced in FIGS. 1 and 2; at least one, but preferably, a plurality of driver magnet(s) 30 as illustrated and referenced in FIGS. 1, 1(a), and 3; and certain magnet-holding, magnet-displacing means 40 as generically referenced in FIG. 1. Disc assembly 20 preferably comprises a circular, non-ferromagnetic disc member 21 as further illustrated and referenced in FIGS. 1, 1(a), 2, and 3; a disc shaft or disc axle 22 as illustrated and referenced in FIGS. 1 and 2; certain bearing means 23 as referenced in FIG. 1; and a plurality of equally and circumferentially-spaced propeller magnets 24 as illustrated and referenced in FIGS. 1, 1(a), 2, and 3.

The disc member 21 preferably comprises an outer periphery 25 as referenced in FIGS. 1, 1(a), 2, and 3; a disc center 26 as referenced in FIG. 1; a first attachment surface 27 as referenced in FIGS. 1, 2, and 3; and a second attachment surface 28 as referenced in FIG. 2. The disc axle 22 comprises an axle axis 100 as generally referenced at a point in FIG. 1, and as a dotted line in FIG. 2. It will be understood from an inspection of the noted figures that the disc axle 22 is cooperable with the disc member 21 and thereby axle axis 100 extends through the disc center 26. The disc member 21 is preferably rotatable (as indicated at arrows 102 in FIGS. 1, 2, and 4) about the axle axis 100, which rotative action may be enhanced by the inclusion or incorporation of bearing means 23. Thus, it will be understood that disc member 21 is preferably rotatably mounted to disc axle 22 via certain bearing means 23.

The propeller magnets 24 may be preferably defined by neodymium (i.e. rare earth) type magnets with a grade of N42 or higher. Each propeller magnet 24 inherently comprises a first propeller pole end 29(a) and a second propeller pole end 29(b) as referenced in FIG. 3; and a propeller magnet axis 101 as generally depicted and referenced in FIGS. 1, 1(a), and 3. The propeller magnets 24 are preferably fastened to the first and second attachment surfaces 27 and 28 adjacent to the outer periphery 25 via the second propeller pole ends 29(b) at certain pole-attachment points. It is contemplated that certain fastening means such as strong adhesive(s) or non-ferromagnetic screws and LOCKTITE brand threadlocker may be effectively utilized to fasten propeller magnets 24 to the pole-attachment points. Preferably, the propeller magnets 24 fastened to the first attachment surface 27 are staggered relative to the propeller magnets 24 fastened to the second attachment surface 28 as generally depicted in FIGS. 1, 2, and 3.

When so attached, it is further contemplated that the propeller magnet axes 101 preferably extend in coplanar relation to one another in at least one plane adjacent the axle axis 100. In this regard, it will be recalled that the disc member 21 comprises a second attachment surface 28 and that propeller magnets 24 may be fastened to each of the first and second attachment surfaces 27 and 28. If attached to both surfaces, then certain of the propeller magnet axes 101 extend in coplanar relation in a first plane adjacent (or parallel to) the first attachment surface 27 and certain of the propeller magnet axes 101 extend in coplanar relation in a second plane adjacent (or parallel to) the second attachment surface 28.

It is contemplated that the magnet axes 101 are preferably uniformly and equally angled from a radial line extending intermediate the disc center 26 and the pole-attachment points. Further, it should be noted that the magnet axes 101 do not intersect the axle axis 100 as may be understood from a comparative inspection of FIGS. 1 and 3. The first propeller pole ends 29(a) thus extend non-orthogonally and outwardly from the outer periphery 25. In other words, the magnet axes 101 are angled at degrees other than 90 degrees from the lines tangent to the outer periphery 25 where the magnet axes 101 may be said to intersect the outer periphery 25.

The driver magnet(s) 30 each have a first driver pole end 31(a) and a second driver pole end 31(b) as illustrated and referenced in FIG. 3; and a driver magnet axis 103 as depicted and referenced in FIGS. 1, 1(a), and 3. Each driver magnet 30 is spatially oriented in adjacency to the outer periphery 25. Preferably, if more than one driver magnet 30 is being used to drive the device or assembly 10, the driver magnets 30 are equally circumferentially spaced in adjacency to the outer periphery 25 as generally depicted in FIG. 1. It is contemplated that each driver magnet 30 may be placed into a holder or be cooperatively associated with magnet-holding, magnet-displacing means 40 for enabling linear displacement of the held driver magnet 30. During the installation of propeller magnets 24 and driver magnets 30, it is contemplated that a calibrated Gaussmeter (Magnetometer) be utilized to verify the magnetic field strength of the magnets 24 and 30, in addition to the proper pole positioning.

Each first driver pole end 31(a) and the first propeller pole ends 29(a) have like magnetic poles, and may be preferably defined by northern magnetic poles. Conversely, each second driver pole end 31(b) and the second propeller pole ends 29(b) may be preferably defined by southern magnetic poles. Notably, like magnetic poles are magnetically repulsive to one another, and thus operate to forcefully repel one another as generally depicted in FIG. 1(a) at vector arrows 110. An upwardly directed vector arrow 110 has been reproduced in FIG. 1(b). It will be seen from an inspection of FIG. 1(b) as well as from a consideration of common vector principles, that vector arrow 110 may be aligned on a coordinate system (for example, X-Y grid) and broken down into component vectors 110x and 110y. Component vector 110x, being structurally and forcefully unopposed*, (in contradistinction to vector component 110y), thus causes motion in the x-direction. The motion creates a torsional effect on the disc member 21. The sum of unopposed forces may thus contribute to rotational motion of the disc member 21. *The notion being addressed here is that the unopposed force is really a net force in the x-direction. Certain opposing forces are overcome by the component force as represented by vector 110x.

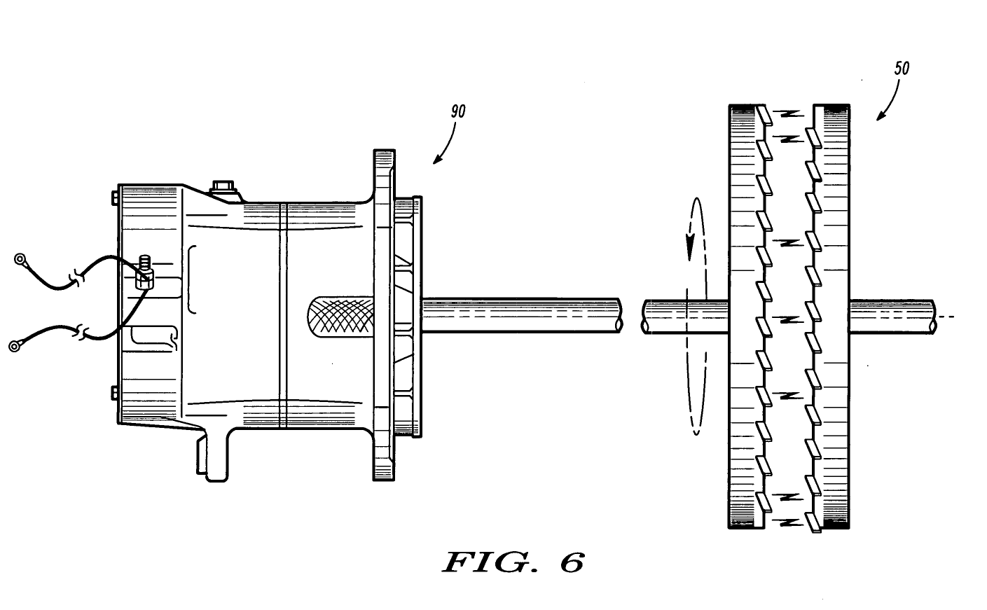

Bearing these notions in mind, it is contemplated that the driver magnet(s) 30 are linearly displaceable by way of the magnet-displacing means 40 adjacent the outer periphery 25 and as indicated at vector arrows 111 in FIG. 1. The linearly displaceable driver magnet(s) 30 may thus function to selectively adjust the magnetic repulsion (force) intermediate the like magnetic poles for imparting rotational motion to the disc assembly 20. Preferably, it is contemplated that driver magnets 30 be driven simultaneously toward (or away from) propeller magnets 24. As the distance between the angled propeller magnets 24 and the driver magnets 30 is reduced, more (repulsive) force is generated, creating a torsional effect on the disc member 21, and causing disc rotation. The rotational disc assembly 21 may thus function to generate energy, as may be harnessed by way of the disc shaft or disc axle 22 in cooperation with certain rotational motion-harnessing means or hardware such as, but not limited to, turbines, electric motors, generators, alternators, drive shafts, etc. A generic rotational motion-harnessing device 90 is illustrated and depicted in FIG. 6.

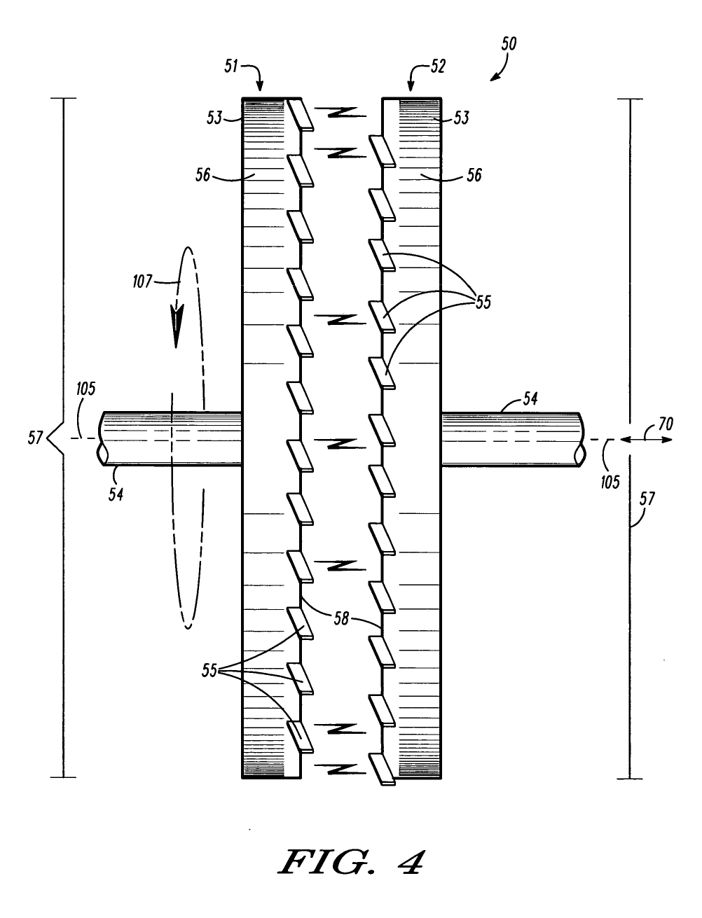

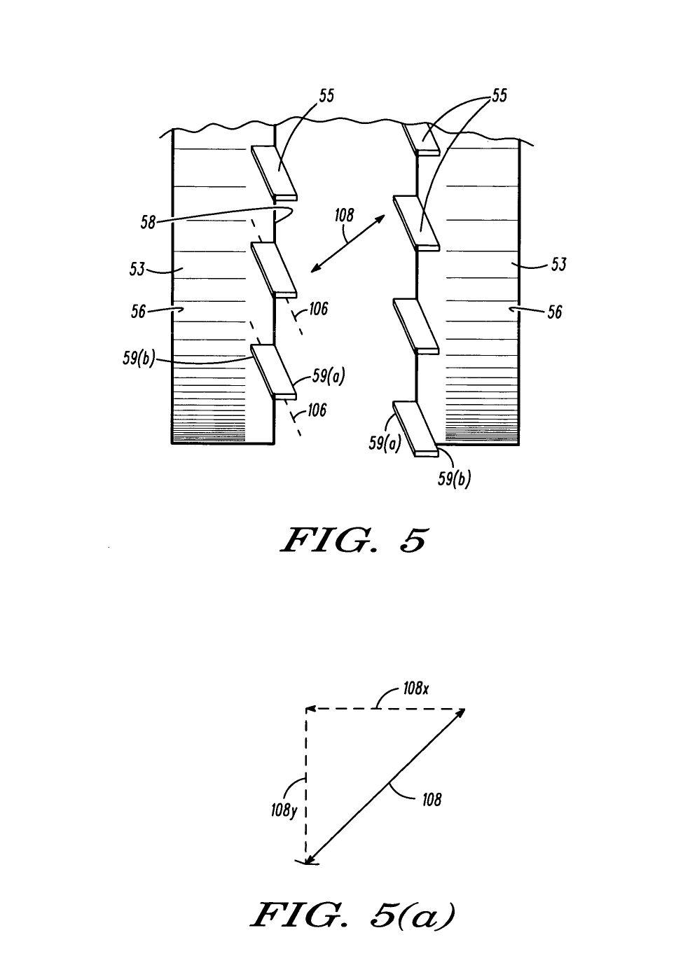

A first alternative embodiment of the present invention concerns an energy-generating assembly 50 as generally illustrated and referenced in FIGS. 4 and 6. Energy-generating assembly 50 preferably comprises similar or like first and second disc assemblies 51 and 52 and certain disc-displacing means as generically depicted by force vectors 70 in FIG. 4. Each of the disc assemblies 51 and 52 preferably comprise a circular, non-ferromagnetic disc member 53 as illustrated and referenced in FIGS. 4 and 6; a disc axle 54 as illustrated and referenced in FIG. 4; and a plurality of circumferentially spaced propeller magnets 55 as illustrated and referenced in FIGS. 4 and 5. First disc assembly 51 may be said to differ from second disc assembly 52 in that first disc assembly 51 may preferably comprise certain bearing means (akin to the previously specified and/or exemplified bearing means), which bearing means function to allow the cooperable disc member 53 to rotate about an axis extending through its disc axle 54.

Each disc member 53 comprises an outer periphery 56 as referenced in FIGS. 4 and 5; a disc center (not specifically shown), a substantially uniform or equal disc diameter 57 as depicted in FIG. 4; and a planar disc-opposing surface 58 as referenced in FIGS. 4 and 5. Each disc axle 54 comprises an axle axis 105 as depicted and referenced in FIG. 4. The disc axles 54 are cooperable with the disc members 53 and thereby the axle axes 105 extend through the disc centers (the axes 105 being collinear).

From an inspection of FIG. 5, it will be seen that propeller magnets 55 (preferably of the neodymium grade N42 or higher type) of the first disc assembly 51 are substantially equally spaced from one another and the propeller magnets 55 of the second disc assembly 52 are substantially equally spaced from one another. Further each comprises a first propeller pole end 59(a) and a second propeller pole end 59(b); and a propeller magnet axis 106. The propeller magnets 55 are preferably fastened (as for example by way of the previously exemplified fastening means) to the outer periphery 56 via the second propeller pole ends 59(b) such that the first propeller pole ends 59(a) extend outwardly from the disc-opposing surfaces 58 as generally depicted in FIGS. 4 and 5. Preferably, the magnet axes 106 are uniformly and equally angled from respective disc-opposing surfaces 58. During the installation of propeller magnets 55, it is contemplated that a calibrated Gaussmeter (Magnetometer) be utilized to verify the magnetic field strength of the magnets 55, in addition to the proper pole positioning.

As may be further gleaned from an inspection of FIGS. 4 and 5, the disc-opposing surfaces 58 of the first and second disc assemblies 51 and 52 oppose one another (the axle axes 105 being collinear). Thus, the first propeller pole ends 59(a) extend toward an opposite disc-opposing surface 58, angled relative thereto. The first disc assembly 51 is rotatable about its axle axis 105 as indicated at vector arrow 107 in FIG. 4, and the second disc assembly 52 is fixed about its axle axis 105. The first propeller pole ends 59(a) (preferably of a northern magnetic pole type) preferably have like magnetic poles, the like magnetic poles being magnetically repulsive to one another. The first and second disc assemblies 51 and 52 are axially displaceable relative to one another (along the axes 105) via the disc-displacing means as generically referenced or depicted at 70.

The axially displaceable disc assemblies 51 and 52 function to selectively and effectively adjust the magnetic repulsion (forces) intermediate the like magnetic poles for imparting rotational motion to the first disc assembly 51. As the distance between the opposing like poles is reduced, more (repulsive) force is generated as depicted and referenced at vector arrow 108 in FIGS. 5 and 5(a). Vector arrow 108 comprises component vectors 108y and 108x. Component vector 108y, being unopposed (in contradistinction to vector component 108x), thus causes motion in the y-direction. The motion creates a torsional effect on the disc member 53 of the first disc assembly 51. The rotational disc assembly 51 may thus function to generate energy, as may be harnessed by way of the disc shaft or disc axle 54 of the first disc assembly 51 in cooperation with certain rotational motion-harnessing means or hardware such as, but not limited to, turbines, electric motors, generators, alternators, drive shafts, etc. A generic rotational motion-harnessing device 90 of the type contemplated is illustrated and depicted in FIG. 6.

While the above description contains much specificity, this specificity should not be construed as limitations on the scope of the invention, but rather as an exemplification of the invention. For example, it is contemplated that a second alternative embodiment of the present invention essentially concerns a hybrid of the preferred embodiment of the energy-generating assembly 10 and the first alternative embodiment of the energy-generating assembly 50. The second alternative embodiment of the present invention may comprises a first disc assembly (such as first disc assembly 51) and a second disc assembly (such as disc assembly 20 (less certain bearing means 23)). Thus, energy-generating disc assembly preferably first and second disc assemblies and certain disc-displacing means as generically depicted by force vectors 70.

The first disc assembly comprises a circular, non-ferromagnetic first disc member 53, a first disc axle 54, and a plurality of circumferentially spaced first propeller magnets 55. The first disc member 53 comprises a first outer periphery 56, a first disc center (not specifically shown or referenced), a first disc diameter (as at 57) and a planar disc-opposing surface 58. The second disc assembly preferably comprises a circular, non-ferromagnetic second disc member 21, a second disc axle 22, and a plurality of circumferentially spaced second propeller magnets 24. The second disc member 21 comprises a second outer periphery 25, a second disc center (such as center 26 shown in FIG. 1), a second disc diameter (as at 81 in FIG. 1), and a first attachment surface 27. The first disc diameter (as at 57) is preferably lesser in magnitude than the second disc diameter (as at 81) to facilitate the placement of propeller magnets 24.

Each of the disc axles 54 and 22 comprise an axle axis such as axle axis 105 and axle axis 100, respectively. The disc axles 54 and 22 are cooperable with the disc members 53 and 21 such that the axle axes 105 and 100 extending through the disc centers. The first and second propeller magnets 55 and 24 each comprise magnetically-opposite pole ends and a magnet axis. The first propeller magnets 55 are fastened to the first outer periphery 56 via magnetically-alike pole ends and the second propeller magnets 24 are fastened to the first attachment surface 27 adjacent to the second outer periphery 25 via magnetically-alike pole ends at pole-attachment points.

The magnet axes of the first propeller magnets 55 extending outwardly toward the first attachment surface 27 angled relative to the disc-opposing surface 58. The magnet axes of the second propeller magnets 24 extend in coplanar relation to one another adjacent to the second axle axis 100 in an axis plane (parallel to first attachment surface 27). Thus, the second propeller magnets 24 extend non-orthogonally and outwardly from the second outer periphery 25. The first and second disc assemblies oppose one another such that the axis plane is substantially parallel to the disc-opposing surface 58 and the axle axes 105 and 100 are collinear.

A first select disc assembly (as selectable from the group consisting of the first and second disc assemblies) has a rotatable axle axis. For example, in FIG. 4, first disc assembly 51 comprises a rotatable axle axis as generally depicted at vector arrow 107. A second select disc assembly (as further selected from the group consisting of the first and second disc assemblies (i.e. the non-selected assembly from the foregoing selection)) has a fixed axle axis. Thus, second disc assembly 20 has a fixed axle-disc assembly and thus no rotation may occur about axis 100. Recall that the bearing means 23 may be removed from disc assembly 20 in this modified version. Thus, the axle 22 may be fixedly attached to disc member 21 and made non-rotatable (although possibly displaceable as at 70). The first and second select disc assemblies may thus be selected from the group consisting of the first and second disc assemblies as set forth hereinabove.

Notably, the like magnetic poles of outwardly extending pole ends are magnetically repulsive to one another. The first and second disc assemblies are axially displaceable relative to one another via the disc-displacing means, the axially displaceable disc assemblies for selectively adjusting the magnetic repulsion (force magnitude) intermediate outwardly extending like magnetic poles for imparting rotational motion to the first select disc assembly for generating energy.

In this last regard, it has been specified, for example, that the first driver pole end 31(a) and the first propeller pole ends 29(a) have like magnetic poles, and may be preferably defined by northern magnetic poles. Conversely, each second driver pole end 31(b) and the second propeller pole ends 29(b) may be preferably defined by southern magnetic poles. In this regard, it is contemplated that the preference for the northern poles to be outwardly-extending need not be incorporated in order for the methodology to be practiced. In other words, it is contemplated that the preferred magnetic orientation of the various magnets set forth hereinabove may very well be reversed and still achieve the same or similar end result.

It is further contemplated that other structural considerations may apply to all the foregoing embodiments. Among these considerations are the possible inclusion of certain magnetic shields, certain module housing, and certain assembly-balancing means. With regard to shielding, it is contemplated that shielding may be added where required as a means to reduce or otherwise control undesirable magnetic fields. With regard to housing for the modules or energy-generating assemblies, it is contemplated that the housing may be fabricated from non-ferromagnetic material(s) and be capable of shielding the bearings and outer area from magnetic influence. With regard to assembly-balancing means, it is contemplated that the cooperable nature of the axes with the disc members may require balancing to improve efficiency and reduce vibrations. The key to the invention lies in the fact that increased energy or energy may thus be produced by reducing the distance between angled magnetic members. Bearing this notion in mind, it is contemplated that multiple discs may be installed on a single shaft or axle to provide additional torque, or increase energy. In all cases, external forces (mechanical or hydraulic, for example) are required to force opposing magnets toward one another so as to create energy by magnetic polar repulsion.

Accordingly, although the invention has been described by reference to certain preferred and alternative embodiments and methodology, it is not intended that the novel disclosures herein presented be limited thereby, but that modifications thereof are intended to be included as falling within the broad scope and spirit of the foregoing disclosure, the following claims and the appended drawings.

We claim:

1. An energy-generating assembly, the energy-generating assembly comprising a disc assembly, at least one driver magnet, and magnet-displacing means, the disc assembly comprising a circular, non-ferromagnetic disc member, a disc axle, and a plurality of circumferentially spaced propeller magnets, the disc member comprising an outer periphery, a disc center, and a first attachment surface, the disc axle comprising an axle axis, the disc axle being cooperable with the disc member, the axle axis extending through the disc center, the propeller magnets each comprising opposing first and second propeller pole ends and a propeller magnet axis, the propeller magnets being fastened to the first attachment surface adjacent the outer periphery via the second propeller pole ends at pole-attachment points, the propeller magnet axes extending in coplanar relation to one another in at least one plane adjacent the axle axis, the first propeller pole ends thus extending non-orthogonally and outwardly from the outer periphery, the disc member being rotatable about the axle axis, each driver magnet having first and second driver pole ends and a driver magnet axis, the magnet-displacing means adjustably mounting each driver magnet in adjacency to the outer periphery, each first driver pole end and the first propeller pole ends having like magnetic poles, the like magnetic poles being magnetically repulsive to one another, each driver magnet being linearly displaceable via the magnet-displacing means, the linearly displaceable driver magnet for selectively adjusting the magnetic repulsion intermediate like magnetic poles for imparting rotational motion to the disc assembly, the rotational disc assembly for generating energy.

2. The assembly of claim 1 wherein the propeller magnets are equally spaced from one another.

3. The assembly of claim 1 wherein the disc member comprises a second attachment surface, the propeller magnets being fastened to the first and second attachment surfaces.

4. The assembly of claim 3 wherein the propeller magnets fastened to the first attachment surface are staggered relative to the propeller magnets fastened to the second attachment surface.

5. The assembly of claim 1 wherein the magnet axes are uniformly and equally angled from a radial line extending intermediate the disc center and the pole-attachment points.

6. The assembly of claim 1 wherein each second driver and propeller pole end comprises a southern magnetic pole and each first driver and propeller pole end comprises a northern magnetic pole.

7. The assembly of claim 1 comprising a plurality of driver magnets, the driver magnets being equally and circumferentially spaced in outer adjacency to the outer periphery.

8. The assembly of claim 1 comprising bearing means, the bearing means being cooperatively associated with the disc axle and the disc member for enabling enhanced rotational motion therebetween.

9. An energy-generating assembly, the energy-generating assembly comprising like first and second disc assemblies and disc-displacing means, each disc assembly comprising a circular, non-ferromagnetic disc member, a disc axle, and a plurality of circumferentially spaced propeller magnets, each disc member comprising an outer periphery, a disc center, a disc diameter and a planar disc-opposing surface, each disc axle comprising an axle axis, the disc axles being cooperable with the disc members, the axle axes extending through the disc centers, the propeller magnets each comprising opposing first and second propeller pole ends and a propeller magnet axis, the propeller magnets being fastened to the outer periphery via the second propeller pole ends, the disc-opposing surfaces of the first and second disc assemblies opposing one another, the axle axes being collinear, the first propeller pole ends extending toward an opposite disc-opposing surface, angled relative thereto, the first disc assembly being rotatable about its axle axis, the second disc assembly being rotatably fixed relative to its axle axis, the first propeller pole ends having like magnetic poles, the like magnetic poles being magnetically repulsive to one another, the first and second disc assemblies being axially displaceable relative to one another via the disc-displacing means, the axially displaceable disc assemblies for selectively adjusting the magnetic repulsion intermediate the like magnetic poles for imparting rotational motion to the first disc assembly, the rotational first disc assembly for generating energy.

10. The assembly of claim 9 wherein the disc diameters of the first and second disc assemblies are substantially equal in magnitude.

11. The assembly of claim 9 wherein the propeller magnets of the first disc assembly are substantially equally spaced from one another and the propeller magnets of the second disc assembly are substantially equally spaced from one another.

12. The assembly of claim 9 wherein the magnet axes are uniformly and equally angled from respective disc-opposing surfaces.

13. The assembly of claim 9 wherein the second propeller pole ends each comprise a southern magnetic pole and the first propeller pole ends each comprise a northern magnetic pole.

14. The assembly of claim 9 wherein the first disc assembly comprises bearing means, the bearing means being cooperatively associated with the disc axle and the disc member for enabling enhanced rotational motion therebetween.

15. An energy-generating assembly, the energy-generating assembly comprising first and second disc assemblies and disc-displacing means, the first disc assembly comprising a circular, non-ferromagnetic first disc member, a first disc axle, and a plurality of circumferentially-spaced, first propeller magnets, the first disc member comprising a first outer periphery, a first disc center, a first disc diameter and a planar disc-opposing surface, the second disc assembly comprising a circular, non-ferromagnetic second disc member, a second disc axle, and a plurality of circumferentially-spaced, second propeller magnets, the second disc member comprising a second outer periphery, a second disc center, a second disc diameter, and a first attachment surface, each disc axle comprising an axle axis, the disc axles being cooperable with the disc members, the axle axes extending through the disc centers, the first and second propeller magnets each comprising magnetically-opposite pole ends and a magnet axis, the first propeller magnets being fastened to the first outer periphery via magnetically-alike pole ends, the second propeller magnets being fastened to the first attachment surface adjacent the outer periphery via magnetically-alike pole ends at pole-attachment points, the magnet axes of the first propeller magnets extending outwardly toward the first attachment surface angled relative to the disc-opposing surface, the magnet axes of the second propeller magnets extending in coplanar relation to one another adjacent the second axle axis in an axis plane, the second propeller magnets extending non-orthogonally and outwardly from the second outer periphery, the first and second disc assemblies opposing one another such that the axis plane is substantially parallel to the disc-opposing surface, the axle axes being collinear, a first select disc assembly having a rotatable axle axis, a second select disc assembly having a rotatably fixed axle axis, the first and second select disc assemblies being selected from the group consisting of the first and second disc assemblies, the like magnetic poles of outwardly extending pole ends being magnetically repulsive to one another, the first and second disc assemblies being axially displaceable relative to one another via the disc-displacing means, the axially displaceable disc assemblies for selectively adjusting the magnetic repulsion intermediate outwardly extending like magnetic poles for imparting rotational motion to the first select disc assembly, the rotational first select disc assembly for generating energy.

16. The assembly of claim 15 wherein the first disc diameters is lesser in magnitude than the second disc diameter for facilitating interaction intermediate the first and second propeller magnets.

17. The assembly of claim 15 wherein the propeller magnets of the first disc assembly are substantially equally spaced from one another and the propeller magnets of the second disc assembly are substantially equally spaced from one another.

18. The assembly of claim 15 wherein the magnet axes of the first propeller magnets are uniformly and equally angled from the disc-opposing surface and the magnet axes of the second propeller magnets are uniformly and equally angled from the first attachment surface.

19. The assembly of claim 15 wherein the outwardly extending pole ends are defined by northern magnetic poles.

20. The assembly of claim 15 wherein the select first disc assembly comprises bearing means, the bearing means being cooperatively associated with the disc axle and the disc member for enabling enhanced rotational motion therebetween.
